(19) United States
(12) Patent Application Publication
(10) Pub. No.: US 2004/0145567 A1
(43) Pub. Date: Jul. 29, 2004

(54) Inductively charged wireless mouse

(76) Inventor: Hsin Lin Ho, Taipei (TW)

Correspondence Address: BACON & THOMAS, PLLC, 625 SLATERS LANE, FOURTH FLOOR, ALEXANDRIA, VA, 22314

(21) Appl. No.: 10/350,021

(22) Filed: Jan. 24, 2003

(51) Int. Cl. G09G 5/08

(52) U.S. Cl. 345/163

(57) ABSTRACT

An inductively charged wireless mouse is characterized in a coil and a charge-accumulating element provided in the wireless mouse. When the wireless mouse is in a stage of power shortage, it may be inductively charged by connecting it to a corresponding charger, which includes a coil inducible with the coil of the wireless mouse, so that a power input may be transmitted from the charger to charge-accumulating element of the wireless mouse, making the wireless mouse fully charged to perform wireless transmission of signals in a best working condition.

### FIELD OF THE INVENTION

The present invention relates to an inductively charged wireless mouse, more particularly to a wireless mouse being internally provided with a coil and a charge-accumulating element to enable charging of the wireless mouse by induction.

### BACKGROUND OF THE INVENTION

Generally, a wireless mouse is charged by conduction. That is, charging of the wireless mouse is implemented through contact of two metal contacts separately provided on the mouse and a charger. For example, the wireless mouse is provided with a round-shaped metal jack while a corresponding charger is provided with an elastic metal pin. By contacting the elastic metal pin of the charger with the round-shaped metal jack on the wireless mouse, the mouse is charged. A problem with this type of charging structure is the metal contacts tend to oxidize after being used for a long time to result in an increased impedance and accordingly difficulty or even failure in charging. Another problem with the conduction charging is the elastic metal pin on the charger is subject to elastic fatigue after being used for a long time to result in non-contact of it with the round-shaped metal jack on the wireless mouse and failure in charging the mouse via the charger.

An alternative way to charge a wireless mouse in the state of power shortage is to externally provide on the mouse with a power supply connection for connecting to a charging power cord. Since the wireless mouse with the charging power cord connected thereto is restricted to move within a limited range, it is, as a matter of fact, the same as a general wired mouse. Moreover, frequent movements of the wireless mouse would result in quick wear of an outer insulating layer of the charging power cord to dangerously expose internal conductors and cause current leakage.

Taiwanese patent application No. 86200135, which has been granted a patent, discloses an induction type wireless mouse. The disclosed wireless mouse is provided with a coil, a power supply circuit, keys and an optical gate, a coding oscillating circuit, and a modulated output, and obtains power from a separate main unit that is provided with a power-supply indicating circuit, an oscillating circuit, a LC modulation circuit, an amplification and filter circuit, and a coil. The wireless mouse disclosed in Taiwanese patent application No. 86200135 is characterized in that it obtains power supply and transmits signals all through inductive action. In addition, the mouse itself does not require any transmission line and battery, and the main unit is in the form of a mouse pad. However, the wireless mouse without accumulating function can be used only on the specific mouse pad. Once the mouse is moved out of the specific mouse pad, it would not be able to obtain power supply and transmit signals by induction. Moreover, since the specific mouse pad must be connected to a mainframe of a computer system via a power cord and limited by the power cord to a restricted working area, the wireless mouse designed for working on the specific mouse pad is also limited to the same restricted working area and can not be freely used in different environments.

It is therefore tried by the inventor to develop an improved inductively charged wireless mouse to eliminate the drawbacks existed in various types of conventional wireless mouse.

### SUMMARY OF THE INVENTION

A primary object of the present invention is to provide an inductively charged wireless mouse that can be used without being restricted by a charging line.

To achieve the above and other objects, the inductively charged wireless mouse of the present invention mainly includes a wireless mouse and a corresponding charger. The charger internally includes a circuit board having a transformer and a coil, and the wireless mouse internally includes a power circuit and a radio frequency emission circuit. The wireless mouse is characterized in a coil and a charge-accumulating element included in the power circuit. The coil in the wireless mouse and the coil in the charger are mutually inducible for a power input to transmit from the charger to the charge-accumulating element of the wireless mouse, so that the wireless mouse is charged by induction.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing an inductively charged wireless mouse and a corresponding charger according to a preferred embodiment of the present invention;

FIG. 2 is a side view of FIG. 1;

FIG. 3 is an assembled top view of FIG. 1; and

FIG. 4 is a schematic circuit diagram showing circuits for the inductively charged wireless mouse of the present invention.

### DETAILED DESCRIPTION OF THE PREFERRED EMBODIMENTS

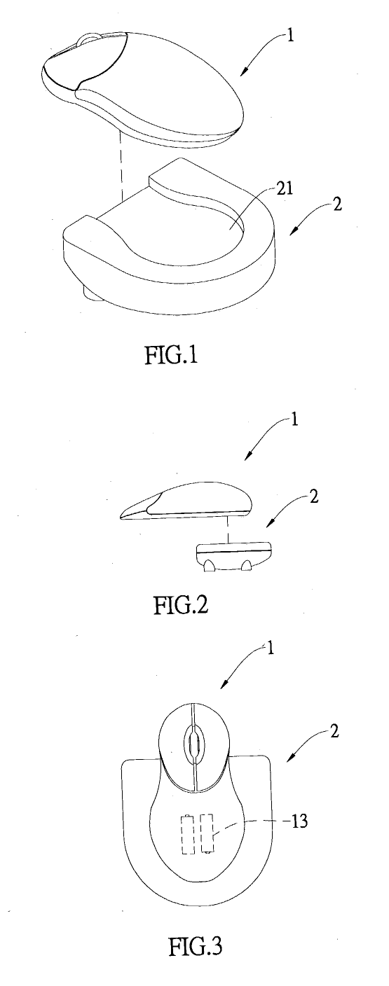

Please refer to FIGS. 1 to 3 that are perspective, side, and top views, respectively, of an inductively charged wireless mouse 1 and a corresponding charger 2 thereof according to a preferred embodiment of the present invention. As shown, there is not any exposed metal contact provided on the wireless mouse 1 and the charger 2. When the wireless mouse 1 is in a state of power shortage or is not in use, a user may position it in a recess 21 provided on the charger 2, so that a charge-accumulating element 13, such as a battery, inside the wireless mouse 1 is charged by induction.

With the induction charging, it is not necessary for a user to align the charger 2 with the wireless mouse 1 at any metal contacts provided thereon, and the charging of the wireless mouse 1 can therefore be more conveniently completed. In addition, the induction charging has a low charging voltage to avoid any electromagnetic interference with normal operation and performance of other peripherals of a computer system with which the wireless mouse 1 is working.

With the induction charging, power supply to the wireless mouse 1 would not have an increased impedance to adversely affect a power transmission thereof even if the wireless mouse 1 is frequently used or has been used for a prolonged time. In addition, the wireless mouse 1 is not subject to a charging fatigue state and is always in a best working condition even if it is in a charging state over a prolonged time. Therefore, the wireless mouse 1 has exactly the same functions as a wired mouse while it is not restricted by a signal line as the wired mouse would be. In practical use, the inductively charged system of the wireless mouse 1 has a less complicate structure and a reduced current demand by different components thereof, enabling the charge-accumulating element 13 in the mouse 1 to have extended duration of service and reduced power consumption to effectively reduce the cost of the wireless mouse 1.

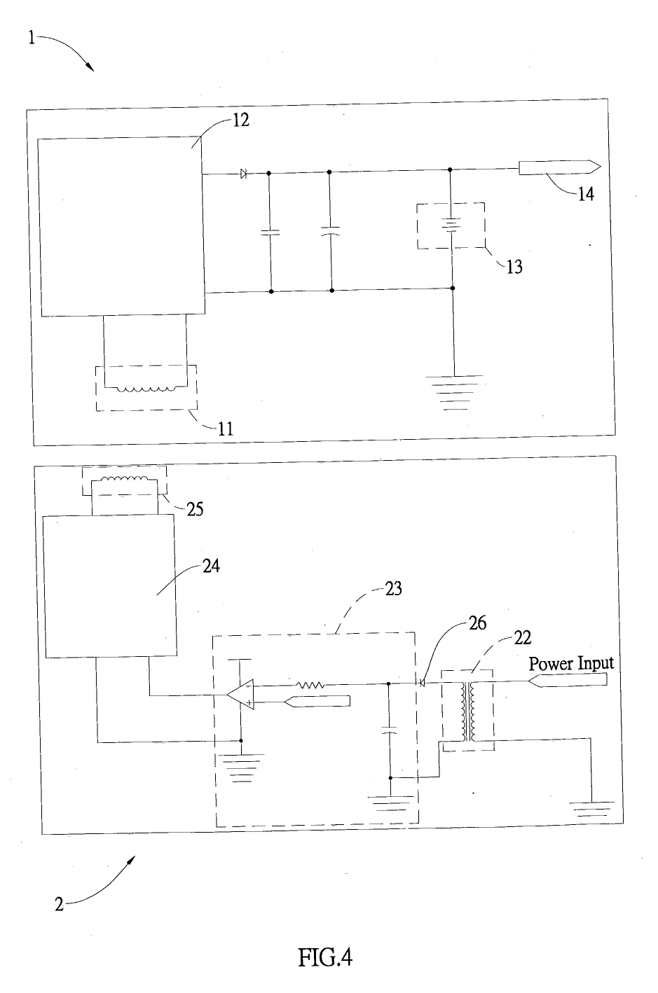

Please refer to FIG. 4 that is a circuit diagram for the wireless mouse land the charger 2. When the charger 2 is switched on, an alternating current (AC) is input thereto. The input alternating current is transformed to a lower voltage via a transformer 22 and then filtered by a diode 26 into a direct current (DC). The direct current flows through an oscillating circuit 23 and is converted into an alternating current again. The converted alternating current flows through a transmission circuit 24 to a coil 25, at where the current generates electric energy. A coil. 11 provided inside the wireless mouse 1 is induced by the current flowing through the coil 25 of the charger 2 to generate a current that is supplied to an internal circuit 12 and then to the charge-accumulating element 13 to provide power needed by the wireless mouse 1 to function. The above-described induction charging may achieve effective power transmit without the need of two contacting metal contacts. Therefore, the induction charging has reduced power loss, increased charging speed, and reduced charging time. When the wireless mouse 1 is moved or a key thereof is pushed, the charge-accumulating element 13 supplies the needed power to a radio frequency emission circuit 14 for the same to emit coded signals.

The present invention has been described with a preferred embodiment thereof and it is understood that many changes and modifications in the described embodiment can be carried out without departing from the scope and the spirit of the invention as defined by the appended claims.

What is claimed is:

1. An inductively charged wireless mouse, comprising a wireless mouse and a charger corresponding to said wireless mouse; said charger internally including a circuit board having a transformer and a coil, and said wireless mouse internally including a power circuit and a radio frequency emission circuit; said wireless mouse being characterized in a coil and a charge-accumulating element included in said power circuit; said coil in said wireless mouse and said coil in said charger being mutually inducible for a power supply to transmit from said charger to said charge-accumulating element of said wireless mouse, so that said wireless mouse is charged by induction.

2. The inductively charged wireless mouse as claimed in claim 1, wherein said charge-accumulating element is a battery.
